(19) United States
(12) Patent Application Publication
(10) Pub. No.: US 2012/0274923 A1
(43) Pub. Date: Nov. 1, 2012

(54) OPTICAL STRAIN GAUGE

(75) Inventors: Manfred Kreuzer, Weiterstadt (DE); Karl-Heinz Haase, Pfungstadt (DE); Tobias Kipp, Rodermark (DE); Jochen Maul, Mainz (DE); Hagen Ruppin, Nauheim (DE); Rudolf Schulz, Weiterstadt (DE); Bernd Günther, Karlsruhe (DE)

(73) Assignee: Hottinger Baldwin Messtechnik GmbH, Darmstadt (DE)

(21) Appl. No.: 13/265,979

(22) PCT Filed: Apr. 22, 2010
(86) PCT No.: PCT/DE10/00459

§ 371 Date: May 17, 2012

(30) Foreign Application Priority Data
Apr. 22, 2009 (DE) 10 2009 018 300.0

(51) Int. Cl. G01B 11/16; B05D 5/00

(52) U.S. Cl. 356/32; 427/163.2

(57) ABSTRACT

The invention relates to an optical strain gauge (1) using a glass fibre as a strain sensor. The strain gauge comprises a glass fibre comprising a sheath. The sheath has the following composition: a mixture of polyether ether ketone and an admixture of at least 10 weight percent and a maximum of 40 weight percent of an inorganic filler, with a particle size of between 0.08 [mu]m and 12 [mu]m. The outer diameter of the sheath is between 0.2 mm and 1.2 mm. The ratio D/d between the outer diameter D of the sheath and the diameter d of the glass fibre is between 2 and 6. A pressure of the sheath on the glass fibre is such that essentially no relative movement can occur between the glass fibre and the sheath.

The invention relates to an optical strain gauge using a glass fiber as strain sensor. Utilization of variations of optical properties of materials for measuring material strains is sufficiently known from prior art, especially as the theory is concerned. An arrangement of this kind is shown in DE 100 04 384 C2, for example.

In general, a strain gauge is composed of at least a sensor comprising a glass fiber and a signal line also comprising a glass fiber.

Glass fiber-type strain sensors are designed so as to detect the strain to be measured as accurately as possible. On principle, there are two groups of such sensors. With the sensors of the first group, the glass fiber used for performing measurements is arranged in a sturdy housing. The housing is fixed to the measuring point by bolting, for example, such as described in the documents DE 100 31 412 C2, DE 39 02 997 C1, U.S. Pat. No. 4,761,073 or DE 297 11 958 U1. The advantage of such embodiments is that the sensors arranged in a housing can well be handled and easily be fixed to the object to be measured, as well. Before or after fixing of the housing to the object to be measured, the strain-measuring fiber arranged in it is connected to a glass fiber-type signal line by any of the connecting means known from prior art, such as a connector assembly. However, sensors of this kind and the inherent signal lines having connectors are bulky and, therefore, can be used on measuring points only where there is enough space for fixing them.

However, there are numerous measurement tasks which require strains to be measured at points spatially accessible under difficult conditions. In such cases, it is not possible to use sensors accommodated in bulky housings. With such cases of application, sensors embedded in flexible foils, for example, are used, as described in the document DE 10 2007 008 464 A1 or U.S. Pat. No. 6,720,553 B2. Sensors of such kind have a smaller volume and, therefore, can be used at points where it is impossible to use sensors arranged in sturdy voluminous housing. With narrow spatial conditions, it is also difficult to fix sensors of such kind because the necessary handling actions can not be performed optimally. Sometimes, it is necessary to run the glass fiber tri-dimensionally at the point of measurement, that is, to bend it into different directions. However, it is also very difficult to use a glass fiber embedded in a flat foil made of plastic material, because the foil does not allow it to be bent tri-dimensionally. Hence in practice, it often happens that sensors possessing very good measuring capabilities cannot operate at full potential due to inadequate application.

In case of immobile structures such as bridges, the sensors must be attached on-site, leading to an increase in effort and difficulty of the application while the quality of the attachment may suffer.

Very often, in addition to spatial limitations at the point of measurement, conditions may be exacerbated by aggressive environmental effects, which requires the sensors and the signal lines to be protected correspondingly. Especially, the connecting point between the sensor and the signal line must be protected reliably, which leads to additional effort.

The problems just described render the application of such measuring devices at spatially limited points more difficult and increase the expenses for every single case of application.

Therefore, one object of the invention is to provide a measurement technique which enables a strain measurement to be performed even at spatial limitations and with little effort. Especially, the strain sensor shall easily be fixable and the signal line and the strain sensor as well shall be mechanically sturdy and, to a great extent, insensitive to water and aggressive substances. Another object of the invention is to provide a method of making such a measurement technique.

These objects are solved by an optical strain gauge according to claim 1 and by a method according to claim 10.

According to claim 1, the optical strain gauge comprises a glass fiber having a sheath, wherein the sheath has the following composition: a mixture of poly-ether ether ketone and an inorganic filler in an admixture of at least 10 percent by weight and maximum 40 percent by weight, with a particle size of 0.08 μm to 12 μm. The outside diameter of the sheath is 0.2 mm to 1.2 mm. The ratio D/d between the outside diameter D of the sheath and the diameter d of the glass fiber is 2 to 6. Pressure of the sheath on the glass fiber is such that essentially no relative movement can occur between the glass fiber and the sheath. The pressure of the sheath causes particles of the filler to bite into the glass fiber so that the effect mentioned above is gained.

The advantage of the optical strain gauge according to the invention is that the unit composed of the sensor and the signal line forms a very sturdy optical strain gauge. The strain gauge according the invention is capable of meeting several requirements. It is possible to use a section of the signal line, which can freely be chosen, as sensor and to fasten this section to the measurement point by using an adhesive. The geometry as claimed, combined with the composition of the sheath as claimed, enable the strain of the surface of the measurement point to be transferred excellently onto the glass fiber through the sheath. It is also possible to fasten the optical strain gauge according to the invention at two positions by using an adhesive. In this case also, it can be found out, whether or not the length between both these fastening positions increases.

The strain gauge according to the invention has properties which a good sensor comprises, but also those properties expected from an optimal signal line. It should be emphasized that the line must have sufficient plasticity and sturdiness so that sections thereof can be preformed and, in this state, can be pushed up to the spatially limited measurement points and fastened there by means of an adhesive or in any other way. If it were impossible to deform the optical strain gauge permanently, it would not be possible to realize pre-forming. Due to its resiliency, a section of the signal line, which is to be fastened, could not be stuck on without using additional fixing means. However, under spatially limited conditions at the measurement point, the use of such fixing means is not possible, in many cases. If the optical strain gauge according to the invention were highly rigid, it would not be deformable or it would kink so that the glass fiber breaks.

The composition of the material chosen for the sheath is highly resistant to several chemicals so that the optical strain gauge according to the invention can even be used in a harsh industrial environment.

Another advantage of the strain gauge according to the invention is that a rupture of the glass fiber can be recognized visually when a laser-light source is connected to the glass fiber, for the sheath is transparent and light scattering so that light emerging from the site of rupture is already visible by the naked eye. It is not possible to localize visually a rupture of the fiber when fibers having a metal sheath or a not-transparent plastic sheath are used.

According to claim 2, the pressure of the sheath on the glass fiber is at least 120 N/mm². With such a pressure, essentially no relative movement between the glass fiber and the sheath can occur so that it is possible to measure a strain precisely.

According to claim 3, the glass fiber comprises a glass core and a coating of ORMOCER®. The coating of ORMOCER® has a chemical stability sufficient for applying the sheath onto the glass fiber by extrusion in the process of making the optical strain gauge. This is not the case when typical coatings such as those made of acrylate or polyimide are used.

According to claim 4, the inorganic filler is a silicate; according to claim 5, the inorganic filler is a laminated silicate and, according to claim 6, the inorganic filler is talcum, chalk, calcium carbonate, barium sulfate, boron nitride, silicon dioxide or bentonite. These filler materials can enable the properties of the optical strain gauge according to the invention, which are mentioned above, to be gained.

According to claim 7, the admixture of the inorganic filler is at least 25 percent by weight and maximum 40 percent by weight. This enables the plastic properties to be improved further.

According to claim 8, the admixture of the inorganic filler is at least 27 percent by weight and maximum of 33 percent by weight. This enables the plastic properties to be improved still further.

According to claim 9, the particle size is at least 0.1 μm and maximum 10 μm. These particle sizes enable a good bonding between the sheath and the glass fiber to be gained.

According to claim 10, a method of making an optical strain gauge comprises the following steps: providing of a glass fiber and extruding of a sheath onto the glass fiber. The sheath comprises the following composition: a mixture of poly-ether ether ketone and an inorganic filler in an admixture of at least 10 percent by weight and maximum 40 percent by weight, with a particle size of 0.08 μm to 1.2 μm. The outside diameter of the sheath is 0.2 mm to 1.2 mm. The ration D/d between the outside diameter D of the sheath and the diameter d of the glass fiber is 2 to 6. After termination of the process, a pressure of the sheath on the glass fiber is such that essentially no relative movement between the glass fiber and the sheath can occur. The pressure of the sheath on the glass fiber causes particles of the filler to bite into the glass fiber so that the effect mentioned above is gained.

An optical strain gauge made in accordance with the method according to the invention has those advantageous properties described above in detail.

According to claim 11, parameters of extrusion are chosen so that, after termination of the process, the pressure of the sheath on the glass fiber is at least 120 N/mm². With such a pressure, essentially no relative movement can occur between the glass fiber and the sheath so that it is possible to measure a strain precisely.

According to claim 12, the step of providing a glass fiber comprises the step of providing a glass core and the step of applying a coating of ORMOCER® onto the glass core. The coating of ORMOCER® has a chemical stability sufficient for the process of extruding the sheath onto the glass fiber in the process of making the optical strain gauge. This is not true of typical coatings such as those made of acrylate or polyimide.

According to claims 13, the inorganic filler is a silicate; according to claim 14, the inorganic filler is a laminated silicate, and according to claim 15, the inorganic filler is talcum, chalk, calcium carbonate, barium sulfate, boron nitride, silicon dioxide or bentonite. These filler materials enable the properties of the optical strain gauge according to the invention, which are mentioned above, to be gained.

Below, the invention will be explained in detail by means of an exemplified embodiment in connection with schematic drawings.

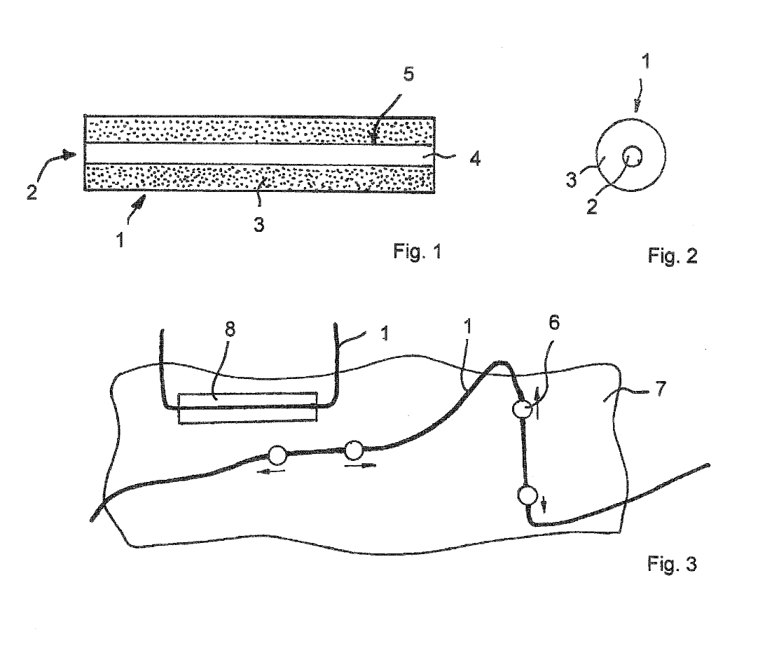

FIG. 1 is a longitudinal cross section of the optical strain gauge according to the exemplified embodiment, in a magnified scale.

FIG. 2 is a cross-sectional view of the optical strain gauge according to the exemplified embodiment, in a magnified scale.

FIG. 3 shows the optical strain gauge according to the exemplified embodiment, attached to the surface of a material.

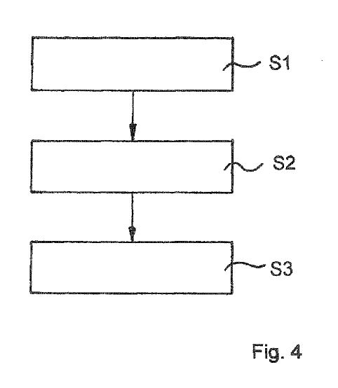

FIG. 4 is a flow chart illustrating fundamental steps of a method of making the optical strain gauge according to the exemplified embodiment.

FIG. 1 shows a longitudinal cross section of an optical strain gauge 1 according to the exemplified embodiment, in a magnified scale. Reference mark 2 denotes a glass fiber and reference mark 3 a shell or sheath.

FIG. 2 shows a cross-sectional view of the optical strain gauge 1 according to the exemplified embodiment, in a magnified scale. The glass fiber 2 is co-axially arranged in the shell or sheath 3.

The sheath 3 can comprise the following composition: a mixture of poly-ether ether ketone and an inorganic filler in an admixture of at least 10 percent by weight and maximum 40 percent by weight, with a particle size of 0.08 μm to 12 μm, for example. Hereinafter, the poly-ether ether ketone is called PEEK, whilst the mixture of PEEK and the inorganic filler is called PEEKF.

The inorganic filler can be talcum (magnesium silicate hydrate, Mg3Si4O10(OH)2), chalk, calcium carbonate (CaCO3), barium sulfate (BaSO4), boron nitride (BN), silicon dioxide (SiO2), bentonite (main component (60-80%) is montmorillonite (laminated aluminum silicate, Al2{(OH)2/Si4O10}nH2O))), quartz, (SiO2), aluminum oxide (Al2O3), silicon carbide (SiC), hollow glass spherules, precipitated silicic acid, zinc sulfide (ZnS) or titanium oxide (TiO2).

The glass fiber 2 can comprise a glass core 4 and a coating 5. The coating 5 can be ORMOCER®, for example, that is, an inorganic-organic hybrid polymer.

The outside diameter D of the sheath 3 can be 0.2 mm to 1.2 mm, for example. The ratio D/d between the outside diameter D of the sheath 3 and the diameter d of the glass fiber 2 can be 2 to 6, for example. As the exemplified embodiment is concerned, the diameter d of the glass fiber 2 is 0.185 mm and the outside diameter D of the sheath 3 is 0.6 mm. The material of the sheath 3 is PEEKF and an admixture of talcum (30 percent by weight), with particle sizes of 0.1 μm to 10 μm.

A pressure of the sheath 3 on the glass fiber 2 can be such that essentially no relative movement between the glass fiber 2 so that it is possible to measure a strain precisely. The pressure of the sheath 3 on the glass fiber 2 can be between 120 N/mm² and 216 N/mm².

On making the optical strain gauge 1, the sheath, which the inorganic filler is distributed in, is applied to glass fiber 2 by an extrusion process. Extrusion is performed at a high temperature, because the melting point of PEEKF is more than 370° C. During a slow cooling-down process and from a temperature limit on, at which the PEEKF begins to solidify, a certain pressure per degree of cooling is generated, due to the different material expansions of the glass fiber 2 and the sheath 3. For example, the expansion coefficient of glass can be 0.5 ppm/K and that of PEEKF can be 25 ppm/K, from which a delta of 24.5 ppm/K results. The temperature limit, at which the PEEKF begins to solidify, can be about 170° C., for example. When the temperature is lowered from about 170° C. to about 20° C., the calculation is 150 K×24.5 ppm/K, for example.

Thus, due to the different expansions of the materials which the glass fiber 2 and the sheath 3 are made of, shrinking occurs, with the result that a shrinkage join between the sheath 3 and the glass fiber 2 is formed. Thereby, the sheath 3 is tightly wedged to the glass fiber 2. This is effected by specific parameters of the extrusion process and a specific composition of PEEFK which the sheath is made of.

FIG. 3 shows the attachment of the optical strain gauge 1 according to the exemplified embodiment on the surface of a material. Reference marks 6 denote points on the surface of a material 7 to be examined, at which the optical strain gauge 1 is fixed by means of an adhesive. The optical strain gauge 1 is run rectilinearly between the fixing points 6. When, due to the occurrence of a material strain, the fixing points 6 are moved away from each other, as indicated by arrows, the optical strain gauge 1 is stressed so that a strain can be measured. It is also possible to stick the optical strain gauge 1 through an extended length 8 thereof onto the surface of the material 7. In general, the methods of attachment are known to an expert and, therefore, it is not necessary to explain them in detail.

FIG. 4 is a flow chart illustrating fundamental steps of a method of making the optical strain gauge 1 according to the exemplified embodiment. In step S1, the glass core 4 is provided. In step S2, a coating 5 is applied onto the glass core 4. Together, the steps S1 and S2 constitute the step of providing the glass fiber 2. In step S3, the sheath 3 is extruded onto the glass fiber 2.

With the method of making the optical strain gauge 1 according to the exemplified embodiment, parameters of extrusion can be chosen so that, after termination of the processes, a pressure of the sheath 3 on the glass fiber 2 is such that essentially no relative movement between the glass fiber 2 and the sheath 3 can occur and a strain can be measured precisely. The pressure of the sheath 3 on the glass fiber 2 can be between 120 N/mm² and 216 N/mm², for example.

1. Optical strain gauge having a glass fiber with a sheath, wherein
the sheath comprises the following composition: a mixture of poly-ether ether ketone and an inorganic filler in admixture of at least 10 percent by weight and maximum 40 percent by weight, with a particle size of 0.08 μm to 12 μm,
the outside diameter of the sheath is 0.2 mm to 1.2 mm,
the ratio D/d between the outside diameter D of the sheath and the diameter d of the glass fiber is 2 to 6, and
a pressure of the sheath on the glass fiber is such that essentially no relative movement between the glass fiber and the sheath can occur.

2. Optical strain gauge according to claim 1, wherein the pressure of the sheath on the glass fiber is at least 120 N/mm².

3. Optical strain gauge according to claim 1, wherein the glass fiber comprises a glass core and a coating of ORMOCER®.

4. Optical strain gauge according to claim 1, wherein the inorganic filler is a silicate.

5. Optical strain gauge according to claim 1, wherein the inorganic filler is a laminated silicate.

6. Optical strain gauge according to claim 1, wherein the inorganic filler is talcum, chalk, calcium carbonate, barium sulfate, boron nitride, silicon dioxide or bentonite.

7. Optical strain gauge according to claim 1, wherein the admixture of the inorganic filler is at least 25 percent by weight and maximum 40 percent by weight.

8. Optical strain gauge according to claim 1, wherein the admixture of the filler is at least 27 percent by weight and maximum 33 percent by weight.

9. Optical strain gauge according to claim 1, wherein the particle size is at least 0.1 μm and maximum 10 μm.

10. Method of making an optical strain gauge, which comprises the following steps:
providing (S1, S2) of a glass fiber and
extruding (S3) of a sheath onto the glass fiber, wherein
the sheath comprises the following composition: a mixture of poly-ether ether ketone and an inorganic filler in an admixture of at least 10 percent by weight and maximum 40 percent by weight, with a particle size of 0.08 μm to 12 μm,
the outside diameter of the sheath is 0.2 mm to 1.2 mm,
the ratio D/d between the outside diameter D of the sheath and diameter d of the glass fiber is 2 to 6, and
after termination of the process, a pressure of the sheath on the glass fiber is such that essentially no relative movement between the glass fiber and the sheath can occur.

11. Method according to claim 10, wherein parameters of the extrusion process are chosen so that, after the termination of the process, the pressure of the sheath on the glass fiber is at least 120 N/mm².

12. Method according to claim 10, wherein the step of providing a glass fiber comprises the step (S1) of providing a glass core and the step (S2) of applying a coating of ORMOCER® onto the glass core.

13. Method according to claim 10, wherein the inorganic filler is a silicate.

14. Method according to claim 10, wherein the inorganic filler is a laminated silicate.

15. Method according to claim 10, wherein the inorganic filler is talcum, chalk, calcium carbonate, barium sulfate, boron nitride, silicon dioxide or bentonite.
